(19) United States
(12) Patent Application Publication
(10) Pub. No.: US 2014/0040536 A1
(43) Pub. Date: Feb. 6, 2014

(54) STORAGE MEDIUM USING NONVOLATILE SEMICONDUCTOR STORAGE DEVICE, DATA TERMINAL HAVING THE STORAGE MEDIUM MOUNTED THEREON, AND FILE ERASING METHOD USABLE FOR THE SAME

(71) Applicant: GENUSION INC., Hyogo (JP)

(72) Inventor: Moriyoshi NAKASHIMA, Hyogo (JP)

(73) Assignee: GENUSION INC., Hyogo (JP)

(21) Appl. No.: 13/955,454

(22) Filed: Jul. 31, 2013

(30) Foreign Application Priority Data
Aug. 1, 2012 (JP) 2012-171213
Jul. 31, 2013 (JP) 2013-158920

(51) Int. Cl. G06F 12/02

(52) U.S. Cl. CPC G06F 12/0246
USPC 711/103

(57) ABSTRACT

A storage medium using a nonvolatile semiconductor storage device for erasing data with certainty on a file-by-file basis and preventing an inadvertent file leak as much as possible is provided. A file erasing method includes (a) reading data other than data in a file which is a target of erase from an erase block having the file as the target of erase recorded therein; (b) writing the read data other than the data in the file which is the target of erase to another erase block; and (c) erasing all the data in the erase block in which the file as the target of erase is recorded.

### CROSS REFERENCE TO RELATED APPLICATION

This application is based upon and claims priority to Japanese Patent Applications No. 2012-171213, filed on Aug. 1, 2012 and No. 2013-158920, filed on Jul. 31, 2013; the entire contents of which are incorporated herein by reference.

### FIELD OF THE INVENTION

The present invention relates to a storage medium using a nonvolatile semiconductor storage device, a data terminal having the storage medium mounted thereon, and a file erasing method usable for the same. Specifically, the present invention relates to a storage medium for improving security so that a file can be erased with certainty, a data terminal having the storage medium mounted thereon, and a file erasing method usable for the same.

### DESCRIPTION OF THE RELATED ART

Conventionally, files generated by a personal computer or the like are mainly stored on a USB memory or the like using a NAND flash memory. However, a USB memory or the like may be possibly lost. In the case where a file stored thereon includes sensitive information such as private information or the like or business secrets which need to be kept confidential strictly, a serious business loss may be incurred if such a USB memory is lost. In order to avoid such a loss, files are manually erased based on certain criteria, or software including an algorithm for erasing files at a certain timing is implemented on a personal computer.

For storing a file on a USB memory or the like using a NAND flash memory, a storage area is divided into a data area and a file management area. For erasing a file, the file management area is flagged so that it is merely considered that the corresponding file is “erased”. This merely causes a situation where when the medium such as the USB memory or the like is formatted, the management area is erased and a start address of the file in the data area cannot be specified, which makes it difficult to read the file. In order to erase the file so as not to be unrecoverable, fixed data such as FF or 00 needs to be written in the entire data area. Software for this purpose is known.

In such circumstances, a storage medium which allows data to be erased therefrom with certainty on a file-by-file basis and a file erasing method usable for such a storage medium are desired.

The present applicant has proposed a B4 flash memory, which is a large capacity nonvolatile semiconductor storage device capable of replacing a NAND flash memory. The B4 flash memory provides a significantly larger number of cycles of write and erase, allows data to be written or erased in a shorter time, and requires only a small total power consumption for a write operation and an erase operation. A method for improving security which is preferable for the B4 flash memory and makes a maximum use of the characteristics thereof has been studied.

Patent Document 1: Japanese Laid-Open Patent Publication No. 2006-156925

The present invention has an object of providing a file erasing method for erasing a file from a storage medium using a nonvolatile semiconductor storage device, by which data is erased with certainty on a file-by-file basis and an inadvertent file leak is prevented as much as possible; and a storage medium usable for the method.

### SUMMARY OF THE INVENTION

Provided in an embodiment according to the present invention is a file erasing method for erasing a file from a storage medium which uses a nonvolatile semiconductor storage device including a plurality of erase blocks each including a plurality of memory cells which allow data stored thereon to be erased collectively, the method comprising (a) reading data other than data in a file which is a target of erase from an erase block having the file as the target of erase recorded therein; (b) writing the read data other than the data in the file which is the target of erase to another erase block; and (c) erasing all the data in the erase block in which the file as the target of erase is recorded.

In the file erasing method, steps (a) through (c) may be repeated.

Provided in another embodiment according to the present invention is a file erasing method for erasing a file from a storage medium which uses a nonvolatile semiconductor storage device, the method comprising (a) writing data such that all memory cells each having a file which is a target of erase recorded therein are put into the same electronic state.

In the file erasing method, the nonvolatile semiconductor storage device may include a plurality of erase blocks each including a plurality of memory cells which allow data stored thereon to be erased collectively. The method may further comprise (b) reading data other than data in a file which is a target of erase from an erase block having the file as the target of erase recorded therein; (c) writing the read data other than the data in the file which is the target of erase to another erase block; and (d) erasing all the data in the erase block in which the file as the target of erase is recorded.

In the file erasing method, steps (a) through (d) may be repeated.

Provided in still another embodiment according to the present invention is a file erasing method for erasing a file from a storage medium which uses a nonvolatile semiconductor storage device including a plurality of erase blocks each including a plurality of memory cells which allow data stored thereon to be erased collectively, the method comprising (a) reading data other than data in a file which is a target of erase from an erase block having the file as the target of erase recorded therein; (b) temporarily storing the read data other than the data in the file which is the target of erase to a retract area; (c) erasing all the data in the erase block in which the file as the target of erase is recorded; and (d) writing the read data other than the data in the file which is the target of erase, temporarily stored in the retract area, to the erase block.

In the file erasing method, the retract area may be an erase block other than the erase block in which the file as the target of erase is recorded or may include a RAM. Steps (a) through (d) may be repeated.

Provided in still another embodiment according to the present invention is a storage medium using a nonvolatile semiconductor storage device including a control circuit for performing any of the file erasing methods described above. It is desirable that the nonvolatile semiconductor storage device is a B4 flash memory.

Provided in still another embodiment according to the present invention is a data terminal including any of the storage mediums described above. It is desirable that the storage medium stores user data.

According to the present invention, a storage medium using a nonvolatile semiconductor storage device which allows data to be erased with certainty on a file-by-file basis and thus prevents an inadvertent file leak as much as possible can be provided.

### BRIEF EXPLANATION OF THE DRAWINGS

FIG. 1 is a cross-sectional view showing a structure of a memory cell for performing a B4 write operation.

FIG. 2 is a circuit diagram of a memory cell array including memory cells for performing a B4 write operation.

FIG. 3 is a block diagram of a B4 memory die.

FIG. 4 is a schematic view of a package including a plurality of B4 memory dies.

FIG. 5 shows the relationship among banks, blocks and pages in one die.

FIG. 6 shows a flow of file erase in an embodiment according to the present invention.

FIG. 7 is a flowchart showing a flow of file erase in an embodiment according to the present invention.

FIG. 8 shows a flow of file erase in an embodiment according to the present invention.

FIG. 9 is a block diagram showing a circuit configuration of a USB memory according to the present invention.

FIG. 10 is a block diagram showing a circuit configuration of a data terminal in an embodiment according to the present invention.

FIG. 11 is a block diagram showing a circuit configuration of another data terminal in an embodiment according to the present invention.

### DESCRIPTION OF THE PREFERRED EMBODIMENT

Hereinafter, embodiments for carrying out the present invention will be described. The present invention is not limited to the following embodiments. The embodiments described below may be modified in various manners to carry out the present invention.

Example of B4 Flash Memory

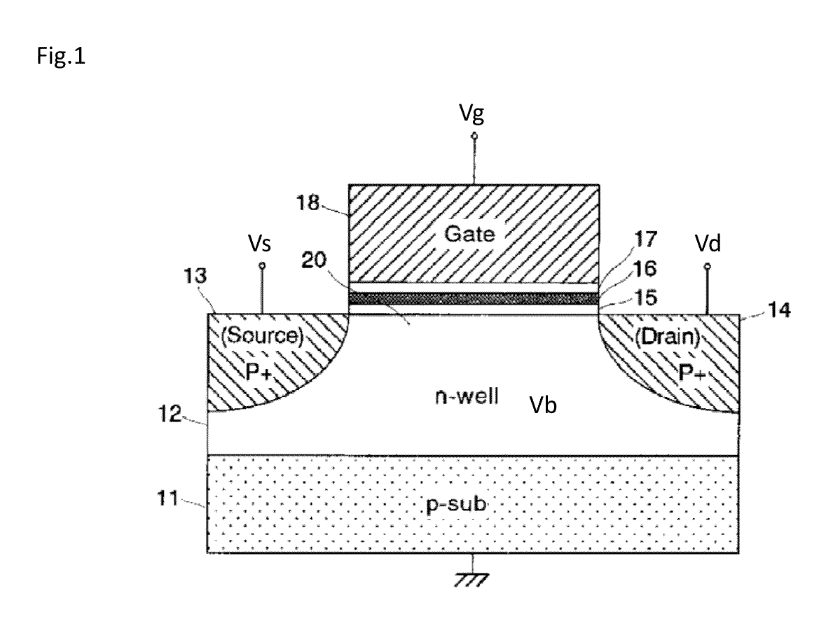

FIG. 1 is a cross-sectional view showing a structure of a memory cell of a B4 flash memory usable in the present invention. Herein, the “B4 flash memory” refers to a flash memory including a memory cell which includes a p-type MOS transistor that is formed in an n-well and has a charge accumulation area such as, for example, a nitride film or a floating gate. In the B4 flash memory, the voltage relationship at the time of write is Vg, Vb>Vs>Vd (where Vg is the gate voltage, Vb is the substrate bias voltage, Vs is the source voltage, and Vd is the drain voltage), and the value of Vg−Vd is equal to or higher than the voltage at which an inter-band tunnel current is generated.

As shown in FIG. 1, the memory cell according to the present invention is a p-type MOS transistor formed in an n-well 12, which is formed on a p-type semiconductor substrate (p-sub) 11. The p-type MOS transistor includes a source 13 and a drain 14, which are p⁺-type diffused areas separated from each other, and also includes a channel region 20 located between the source 13 and the drain 14. On the channel region 20, an ONO film including an oxide film 15, a nitride film 16 and an oxide film 17 is formed. On the ONO film, a gate 18 formed of polycrystalline silicon doped with impurities is provided. A floating gate may be used instead of the nitride film 16. The nitride film 16 or the floating gate forms a charge accumulation layer. Vg is the voltage to be applied to the gate 18, Vb is the substrate bias voltage, Vs is the voltage to be applied to the source 13, and Vd is the voltage to be applied to the drain 14.

Data is read from the memory cell shown in FIG. 1 as follows. The voltage Vd of about 1 V, the voltage Vb of 1.8 V (equal to the power supply voltage Vcc), the voltage Vs of 1.8 V, and the voltage Vg of, for example, −2.2 V (corresponding to the voltage among a plurality of states in the case of a multi-level cell) are applied. When the threshold value of the memory cell is lower than −2.2 V, a current flows; whereas when the threshold value of the memory cell is higher than −2.2 V, a current does not easily flow. The difference between the threshold value and −2.2 V is detected to make a determination on written data.

Data is written to the memory cell shown in FIG. 1 as follows. The voltage Vd of 0 V, the voltage Vb of 4.5 V, the voltage Vs of 1.8 V, and the voltage Vg of, for example, 7 V are applied. Then, the written data is verified by a verify operation (operation of reading data at a slightly strict condition of, for example, Vg=−3.0 V). The above-mentioned write voltages are applied in repetition until a target threshold value is obtained. Among the write voltages, the voltage Vg is gradually raised each time the write cycle is repeated, and is raised to 12 V at the maximum.

Data is erased from the memory cell shown in FIG. 1 as follows. The voltage Vd is opened, and the voltage Vg is made −10 V and the voltage Vs is made equal to the voltage Vb. The voltage Vg is gradually raised each time the erase cycle is repeated, and is raised to 12 V at the maximum. The erase operation is performed on a block-by-block basis.

In the B4 flash memory described above, the length of the channel region between the source and the drain can be shortened to raise the integration degree, both of the write operation and the erase operation can be performed at a high rate, and the write cycle and the erase cycle are performed by a significantly larger number than in a NAND flash memory. Even after a rewrite operation is performed many times, data can be held stably for a long period of time even at a high temperature.

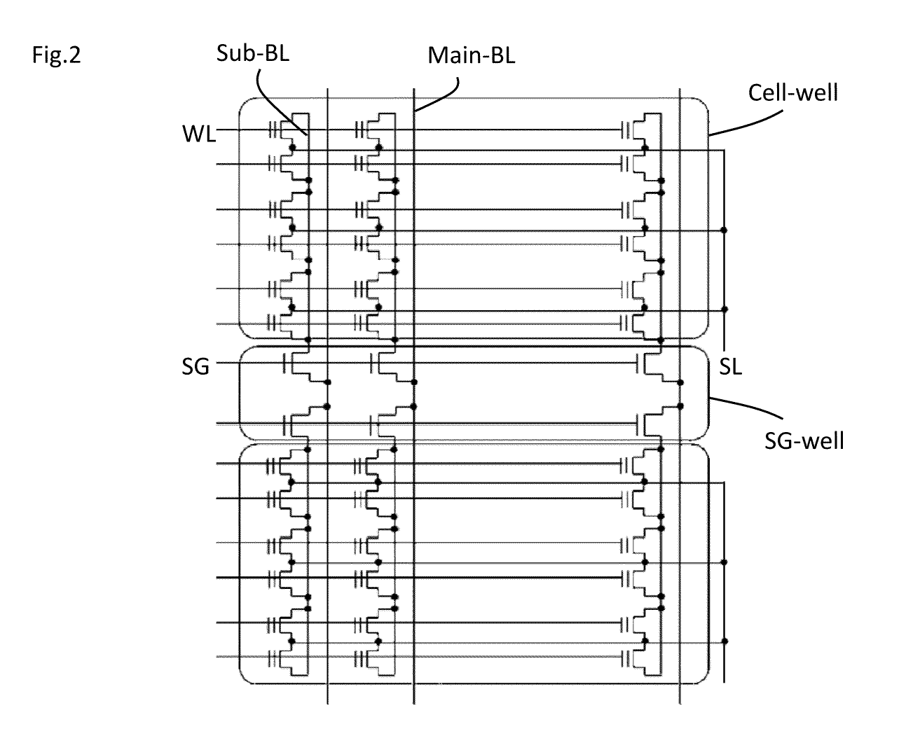

FIG. 2 is a circuit diagram of a memory cell array of the B4 flash memory. In a column direction, n-type cell-wells and p-type select gate wells (SG-wells) are located alternately. Each cell-well includes a plurality of p-type memory cells located in a matrix. The plurality of memory cells included in each cell-well form a block, which is a unit for data erase. Each cell-well is supplied with the bias voltage Vb. The sources of all the memory cells in each block are commonly connected to a source line SL. The voltage Vs is supplied via the source line SL. In each block, the drains of the memory cells belonging to the same column are commonly connected to a sub bit line (Sub-BL). The voltage Vd is supplied via the sub bit line. Lines extending in a row direction are word lines WL. Gate electrodes of the memory cells belonging to the same row are connected to the same word line WL. The memory cells located in each row form a page. The voltage Vg is supplied via each word line. Each select gate well includes a plurality of n-type select gate transistors. Select gate transistors are provided for each column, and each select gate transistor selectively connects a sub bit line and a main bit line corresponding to each other. Gate electrodes of the select gate transistors in the same row are connected to the same select gate line SG.

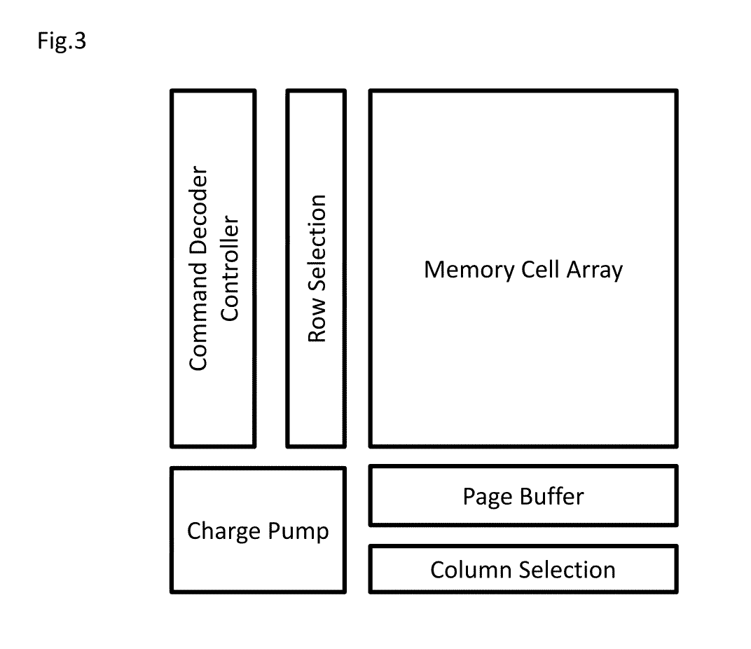

FIG. 3 is a block diagram of a B4 memory die. The B4 memory die includes a row selection circuit for selecting a row of the memory cell array having the circuit shown in FIG. 2, a page buffer for holding data corresponding to one page, namely, one row, a column selection circuit for selecting 16-bit (1-word) data from the data in the page buffer (2-kbit data, i.e., 128-word data), a charge pump circuit for generating and supplying a high voltage, a negative voltage and the like for a write operation, an erase operation and the like, and a command decoder/controller for decoding a command supplied from an external device and controlling various circuits in the B4 memory die.

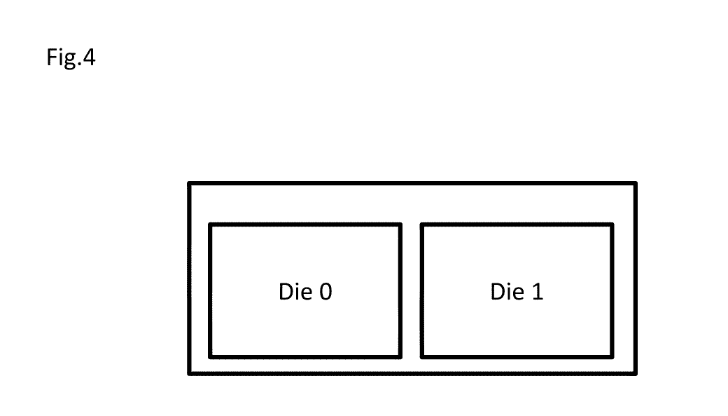

FIG. 4 is a schematic view of a package including a plurality of B4 memory dies. In the example shown in FIG. 4, two dies (Die 0, Die 1) each having a memory capacity of 512 Mbits are enclosed in one package. As a result, the package has a memory capacity of 1 Gbits. The dies respectively include separate chip selection/control signal terminals CE0 and CE1. A multi-level cell (MLC) has a memory capacity which is an integral multiple of the memory capacity of the above-described single-level cell (SLC). In the case where, for example, four threshold value states are stored on one memory cell to hold 2-bit data, the capacity of one die is 1 Gbits. One package including two dies has a memory capacity of 2 Gbits.

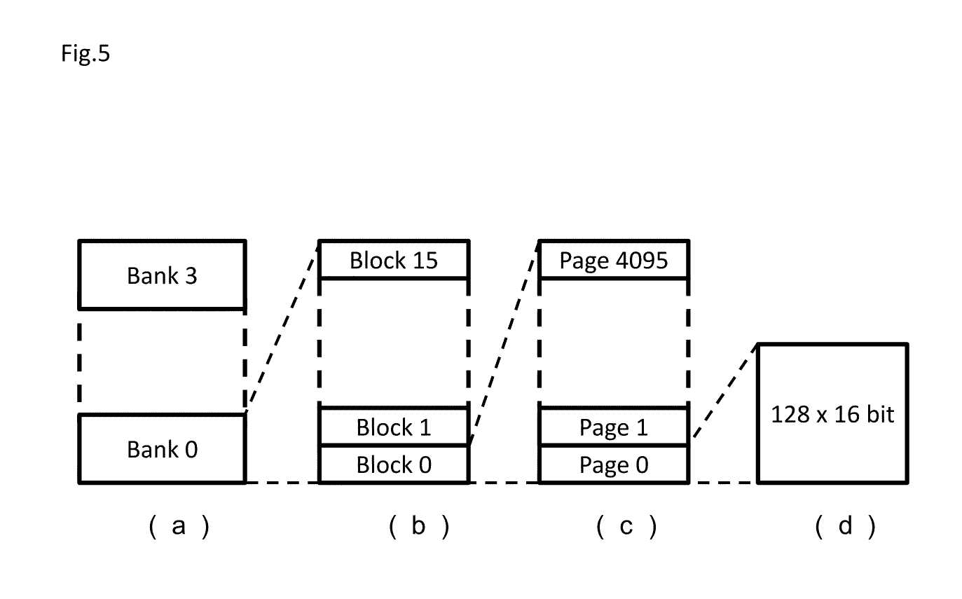

FIG. 5 shows the relationship among banks, blocks and pages in one die. One die includes four banks (Bank 0, Bank 1, Bank 2 and Bank 3). Each bank is divided into 16 blocks (Block 0 through Block 15). Each block is a unit for data erase. Each block is divided into 4096 pages (Page 0 through Page 4095). Each page is a unit for data write. Each page is formed of 2 kbits, namely, 128 words.

File Erasing Method for Improving Security

One through four packages including the B4 flash memories described above form a storage such as a memory card or a USB memory having a capacity of 1 Gb to 8 Gb. Such a storage is connected to a personal computer and is recognized by a user as a drive similar to an HDD or an SSD under the management of an operating system of the personal computer.

On a storage area of the storage, a file managed by the operating system is stored. In general, the size of a document file is several ten kilobits to several ten megabits. Therefore, in many cases, files are recorded over a plurality of pages in one or a plurality of blocks. In many cases, a plurality of files are stored in one block.

According to the file erasing method of the present invention described below, when a file is erased, data in a FAT area is updated and also the substance of the file itself is completely erased physically. Therefore, even if the storage is lost, the data which is once erased is not decrypted. When it is decided not to use a particular storage anymore, the work of overwriting data by use of special software is not necessary. A simple work of erasing data can put the data which is once erased to a non-decryptable state.

File Erasing Method 1

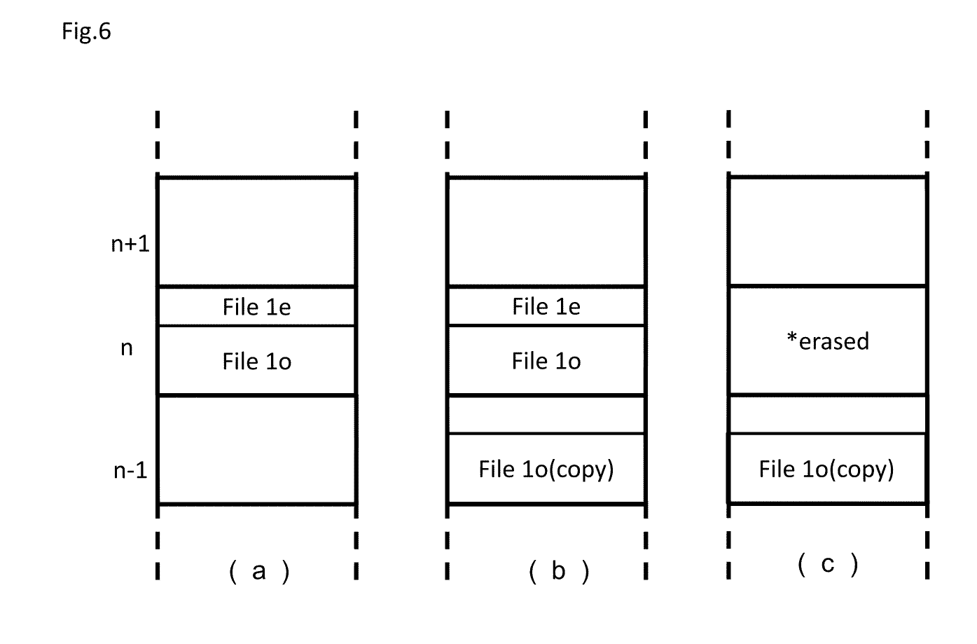

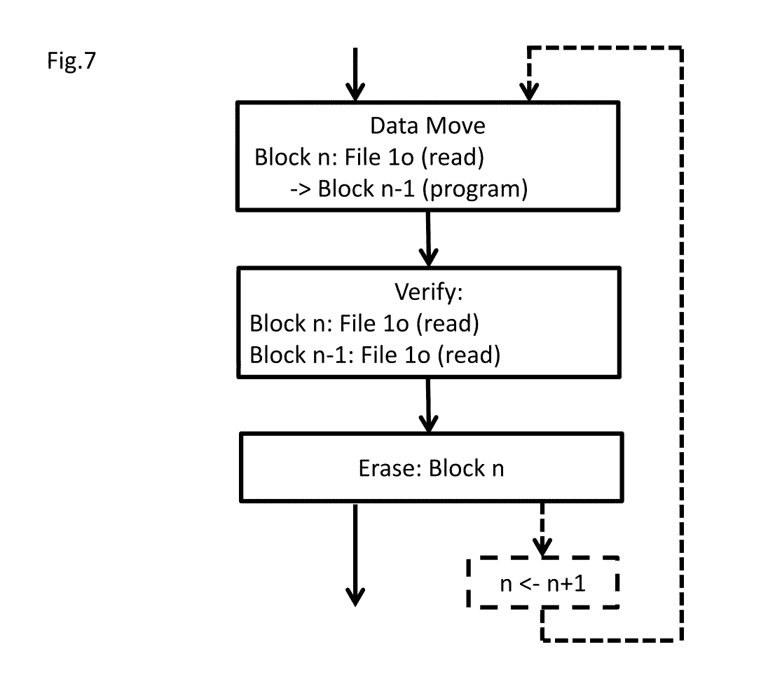

Hereinafter, file erasing method 1 will be described with reference to FIG. 6 and FIG. 7. As shown in FIG. 6(a), data in File 1e and File 1o is stored in block n. Now, it is assumed that File 1e is to be erased by an instruction from the operating system. File 1e is erased as follows. First, as shown in FIG. 6(b), from the erase block n having the file which is the target of erase stored therein, data other than data in File 1e, which is the target of erase, namely, data in file 1o is read and written to erase block n−1 (when n is 0, the data in file 1o is written to block 15). In this state, the data in File 1o stored in block n and the data in File 1o stored in block n−1 are compared page by page to perform a write verify operation. Then, as shown in FIG. 6(c), all the data in erase block n, in which the file as the target of erase is recorded, is erased. In addition, a pointer to the substance of the file in the FAT area is corrected to a new address (the FAT area is stored on the flash memory, but is in a volatile memory area in the controller when in use). Referring to FIG. 7, the flow represented by the solid line arrow shows file erasing method 1 according to the present invention.

A currently available 512 M B4 flash memory is estimated to require the following time periods to perform the above-described steps. For reading data of 1 page, about 4.5 μs is required. Therefore, for reading data of 1 block, 18 ms is required. In the case where four banks have data written in a dispersed manner, the data needs to be read from the four banks. Therefore, a total of 64 ms is required. For writing data of 1 block, about 624 ms is required. For erasing data of 1 block, 100 ms is required. Therefore, the time necessary for a series of sequences (change of data of about 8 Mbytes) does not exceed 1 second. This rate is sufficiently high for practical use.

This file erasing method may be performed by a NAND flash memory, but is preferably performed by the above-described B4 flash memory because a NAND flash memory is restricted in terms of the number of times of rewrite and also because of the following reasons. In the B4 flash memory, the length of the channel region between the source and the drain can be shortened to raise the integration degree, both of the write operation and the erase operation can be performed at a high rate, the write cycle and the erase cycle are performed by a significantly larger number than in the NAND flash memory, and even after a rewrite operation is performed many times, data can be held stably for a long period of time even at a high temperature. File erasing method 1 may be implemented by software by directly controlling a USB memory or the like by an operating system, may be implemented by firmware so as to be controlled by a controller for controlling an interface of the storage (described later), or may be implemented by hardware in a die.

File Erasing Method 2

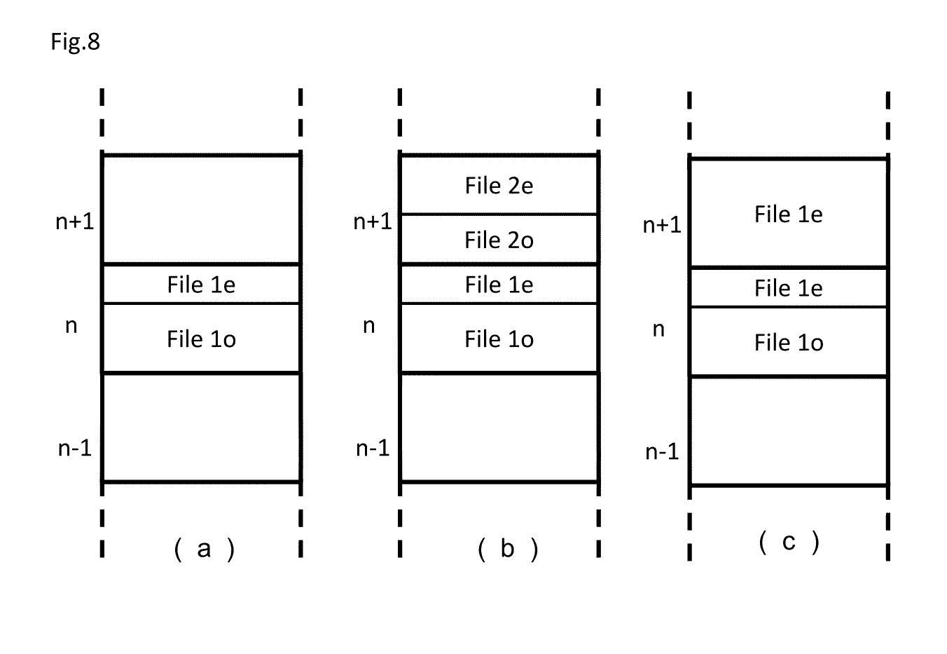

Hereinafter, file erasing method 2 will be described with reference to FIG. 7 and FIG. 8. The flow represented by the dashed line arrow in FIG. 7 shows an example in which file erasing method 2 is repeated a plurality of times. Namely, data move (reading data in File 1o in block n and programming the data to block n−1), data verify (comparing the data in File 1o in block n and the data in File 1o in block n−1 for verification), and erase (erasing block n) are repeated by a plurality of cycles.

FIG. 8(a) shows an example in which merely File 1e, which is a target of erase, is stored in block n. FIG. 8(b) shows an example in which File 1e as the target of erase is stored in block n and File 2e as a target of erase is stored in block n+1. Now, it is assumed that File 1e and File 2e are to be completely erased by an instruction from the operating system. File 1e and File 2e are erased as follows. First, from the erase block n having the file which is the target of erase stored therein, data other than data in File 1e, which is the target of erase, namely, data in file 1o is read and written to erase block n−1. In this state, the data in File 1o stored in block n and the data in File 1o stored in block n−1 are compared page by page to perform a write verify operation. Then, all the data in erase block n, in which the file as the target of erase is recorded, is erased. Then, from the erase block n+1 having the file as the target of erase stored therein, data other than data in File 2e, which is the target of erase, namely, data in file 2o is read and written to erase block n. In this state, the data in File 2o stored in block n+1 and the data in File 2o stored in block n are compared page by page to perform a write verify operation. Then, all the data in erase block n+1, in which the file as the target of erase is recorded, is erased.

As described above, a memory die including 16 blocks can store data of a size up to 15 blocks. One block needs to be kept blank in order to erase the data completely.

File Erasing Method 3

Hereinafter, file erasing method 3 will be described with reference to FIG. 7 and FIG. 8. File erasing method 3 uses the flow represented by the dashed line arrow in FIG. 7, except that the data move (reading data in File to in block n+1 and programming the data to block n) is omitted because only File 1e, which is a target of erase, is stored in block n+1.

File Erasing Method 4

Hereinafter, file erasing method 4 will be described. In file erasing method 4, unlike in file erasing method 1, when an instruction to erase a file is issued, data is written such that all the memory cells in which the file as a target of erase is recorded are put into the same electronic state (written state). As a result, before a block is erased physically in the flash memory, data read is made impossible. The erase operation is performed at a timing when the erase operation is possible. Namely, from the erase block having the file as the target of erase recorded therein, data other than data in the file as the target of erase is read and written to another erase block. Then, all the data in the erase block, in which the file as the target of erase is recorded, is erased.

In file erasing method 4 also, these steps may be repeated.

File Erasing Method 5

Hereinafter, file erasing method 5 will be described. In this file erasing method, data in File 1o, which is other than data in the file as a target of erase, is written again to a block in which the file was originally stored. Namely, from the erase block n having the file as the target of erase recorded therein, data in File 1o other than the data in the file as the target of erase is read, and is temporarily stored in a retract area (RAM area) of the controller. All the data in the erase block n, in which the file as the target of erase is recorded, is erased. Then, the data in File 1o temporarily stored in the RAM area is written again to the erase block n. The retract area may be an erase block other than the erase block in which the file as the target of erase is recorded. The above-described steps may be repeated.

USB Memory

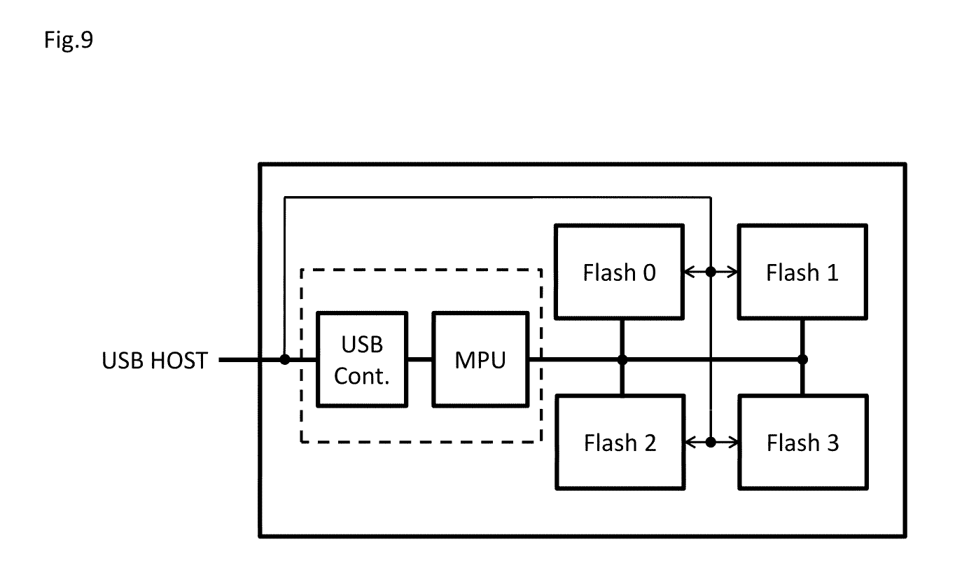

FIG. 9 is a block diagram showing a circuit configuration of a USB memory according to the present invention. The USB memory includes flash memory packages Flash 0 through Flash 3, a controller chip (enclosed by the dashed line in FIG. 9) including a USB controller and an MPU for controlling the flash memories in one chip, and a battery or a capacitor. The controller chip includes a RAM area for converting a logical address transmitted from a USB HOST into a physical address and caching a part of the FAT area or written data. When receiving, from the USB HOST, a complete data erase command which instructs the USB memory to completely erase data, the USB memory performs the steps of any of the above-described file erasing methods. The circuit is implemented in the form of a USB memory herein, but may be implemented in the form of a memory card, a memory module, an SSD or the like.

Data Terminal 100

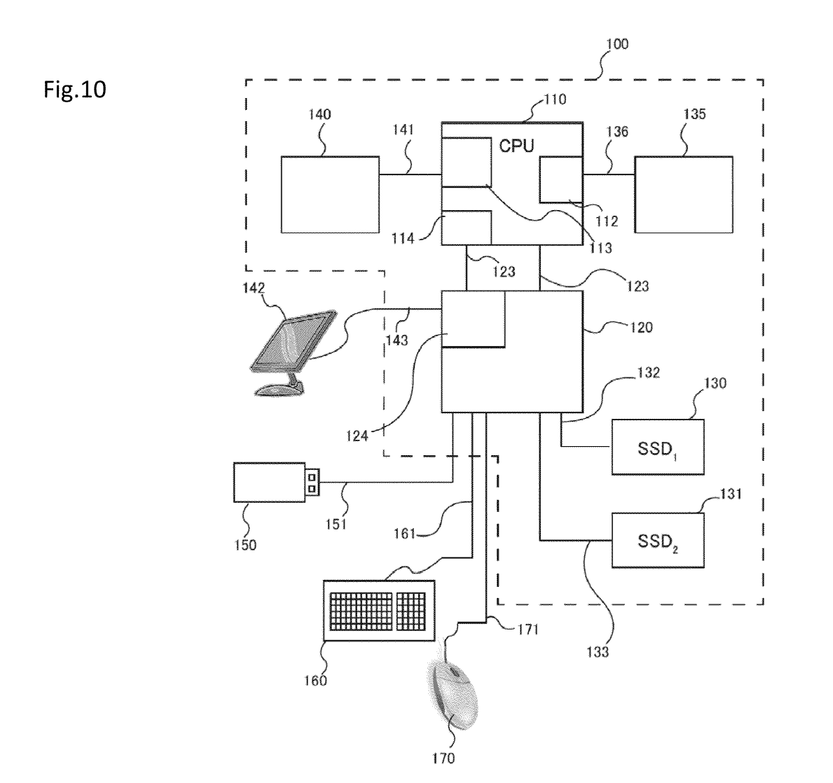

FIG. 10 is a block diagram showing a circuit configuration of the data terminal 100 in an embodiment according to the present invention. The data terminal 100 is provided in the form of a desktop PC, a notebook PC or a tablet PC.

The data terminal 100 is connected to a display 142, a USB memory 150, a keyboard 160 and a mouse 170.

The data terminal 100 includes a CPU 110 for performing computation, a chip set 120 for interfacing with an external device, semiconductor drives 130 and 131 for storing programs (operating system, device driver and application software) and user data, a main memory 135 for temporarily storing any of the programs or user data which is a target of computation performed by the CPU, and a graphic unit 140 for performing image processing.

The CPU 110 includes a memory controller 112 connected to the main memory 135 via a memory bus 136, a graphic bus controller 113 connected to the graphic unit 140 via a graphic bus 141 (e.g., PCI Express 2.0), and a built-in graphic controller 114.

The chip set 120 and the CPU 110 are connected to each other via a CPU bus 123 (e.g., DMI 2.0). The chip set 120 includes a display interface 124 for receiving data from the built-in graphic controller 114 in the CPU 110 or the graphic unit 140 via a flexible display interface bus 123 and outputting the data to the display 142 via a display output bus 143. The chip set 120 is connected to the semiconductor drives 130 and 131 respectively via serial buses 132 and 133 (e.g., SATA 3.0). The USB memory 150, the keyboard 160 and the mouse 170 are connected to the chip set 120 respectively via serial buses 151, 161 and 171 (e.g., USB 3.0).

The semiconductor drives 130 and 131 of the data terminal 100 are structured to perform the steps of any of the file erasing methods described above upon receipt of a complete data erase command, like the USB memory shown in FIG. 9. The semiconductor drives 130 and 131 have substantially the same circuit configuration as that shown in FIG. 9 except for the interface.

As described above, the semiconductor drives 130 and 131 each store a semiconductor drive device driver as well as the operating system. The semiconductor drive device driver includes a program for controlling the CPU 110 and the chip set 120 to transmit a complete erase command to the semiconductor drives 130 and 131. The semiconductor drive device driver includes a program for controlling the CPU 110 and the chip set 120 to perform any of file erasing methods 1 through 5 described above.

As shown in FIG. 9, the USB memory 150 may be structured to perform the steps of any of the file erasing methods upon receipt of a complete data erase command.

The semiconductor drives 130 and 131 each store a USB memory device driver. The USB memory device driver includes a program for controlling the CPU 110 and the chip set 120 to transmit a complete erase command to the USB memory 150. The USB memory device driver includes a program for controlling the CPU 110 and the chip set 120 to perform any of file erasing methods 1 through 5 described above.

Owing to the above-described structure of the data terminal 100, user data which possibly includes sensitive information such as private information or the like or business secrets which need to be kept confidential strictly can be erased with certainty on a file-by-file basis by a complete erase command. As a result, an inadvertent file leak is prevented as much as possible.

In order to realize a high speed operation, it is desirable that the target to be completely erased on a file-by-file basis is only user data, not a program. Whether the data as a target of erase is a program or user data is distinguished by an operating system. The semiconductor drive device driver and the USB memory device driver transmit a complete erase command under an instruction from the operating system.

With the above-described structure of the data terminal 100, it is made possible to erase only the file which contains user data completely. Thus, the time required for completely erasing data can be shortened, which realizes a high speed operation.

Data Terminal 200

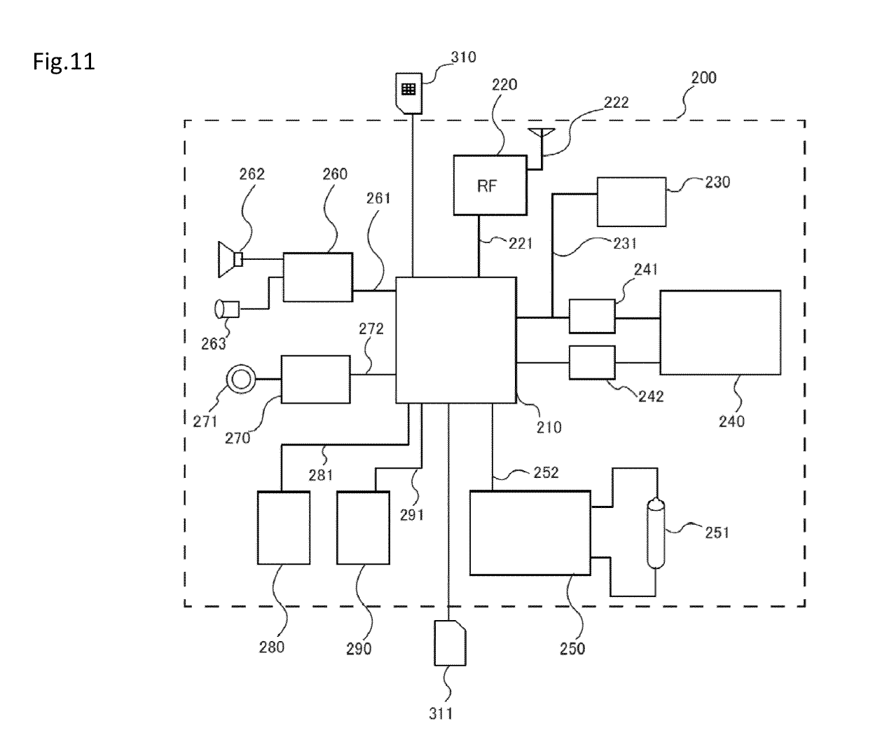

FIG. 11 is a block diagram showing a circuit configuration of a data terminal 200 in an embodiment according to the present invention. The data terminal 200 is provided in the form of a mobile phone, a smart phone or a table mobile terminal.

The data terminal 200 has slots to which a SIM card 310 or a USB memory 311 for storing information can be inserted.

The data terminal 200 includes an application processor 210 for performing computation, a wireless communication unit 220, a sensor 230, a display 240, a power supply management unit 250, an audio unit 260, a camera module 270, a first memory 280 formed of a volatile memory, and a second memory 290 formed of a nonvolatile memory for storing programs (operating system, device driver and application software) and user data.

The wireless communication unit 220 performs communication between the data terminal 200 and an external wireless base station, and is connected to the application processor 210 via a serial bus 221. The wireless communication unit 220 is also connected to an antenna 222.

The sensor 230 includes a temperature sensor, an accelerator sensor, a position sensor, a gyrosensor and the like, and information detected by such sensors is supplied to the application processor 210 via a serial bus 231 (e.g., I2C).

The display 240 is a liquid crystal display or an organic EL display having a touch panel function, and is connected to the application processor 210 via a display interface unit 242 and a touch panel interface unit 241.

The power supply management unit 250 is connected to a lithium ion battery 251, and controls power supply to all the units in the data terminal 200 and charge/discharge of the lithium ion battery 251. The power supply management unit 250 is connected to the application processor 210 via a serial bus 252 (e.g., I2C).

The audio unit 260 is connected to a speaker 262 and a microphone 263, and is connected to the application processor 210 via a serial bus 261 (e.g., I2C).

The camera module 270 is connected to a two-dimensional CMOS sensor 271, and is connected to the application processor 210 via a serial bus 272 (e.g., CSI).

The first memory 280 formed of a volatile memory is connected to the application processor 210 via a memory bus 281. The first memory 280 may be stacked on, and enclosed in the same package with, the application processor 210. The first memory 280 temporarily stores any of the programs (operating system and application software) or user data which is a target of computation.

The second memory 290 formed of a nonvolatile memory is connected to the application processor 210 via a memory bus 291 (e.g., USB 3.0). The second memory 290 may be stacked on, and enclosed in the same package with, the application processor 210. The second memory 290 stores the programs (operating system and application software) and user data.

The second memory 290 in the data terminal 200 is structured to perform the steps of any of the file erasing methods described above upon receipt of a complete data erase command, like the USB memory shown in FIG. 9. The second memory 290 has substantially the same circuit configuration as that shown in FIG. 9 except for the interface.

As described above, the second memory 290 stores the operating system and a semiconductor drive device driver (may be one element of the operating system). The semiconductor drive device driver includes a program for controlling the application processor 210 to transmit a complete erase command to the second memory 290. The semiconductor drive device driver includes a program for controlling the application processor 210 to perform any of file erasing methods 1 through 5 described above.

As shown in FIG. 9, the USB memory 311 may be structured to perform the steps of any of the file erasing methods described above upon receipt of a complete data erase command.

The second memory 290 stores a USB memory device driver. The USB memory device driver includes a program for controlling the application processor 210 to transmit a complete erase command to the USB memory 311. The USB memory device driver includes a program for controlling the application processor 210 to perform any of file erasing methods 1 through 5 described above.

Owing to the above-described structure of the data terminal 200, user data which possibly includes sensitive information such as, for example, a telephone or address list or business secrets which need to be kept confidential strictly can be erased with certainty on a file-by-file basis by a complete erase command. As a result, an inadvertent file leak is prevented as much as possible.

A mobile terminal such as the data terminal 200 may be lent to a plurality of users. The complete erase command according to the present invention mounted on the mobile terminal allows the user data to be erased completely after the mobile terminal is returned from one user so that the mobile terminal can be lent to another user. In the case where the data as a target of erase is limited to user data, the mobile terminal, after being returned from one user, can be lent to another user quickly.

As described above, the present invention can provide a storage medium using a nonvolatile semiconductor storage device which can erase data with certainty on a file-by-file basis and thus prevent an inadvertent file leak as much as possible, and a data terminal including such a storage medium.

What is claimed is:

1. A method for erasing a file from a storage medium having a nonvolatile semiconductor storage device, the nonvolatile semiconductor storage device including a plurality of erase blocks each including a plurality of memory cells allowing data stored thereon to be erased collectively, the method comprising:
(a) reading first data from a first erase block, the first data being different from second data of an file in the erase block;
(b) writing the first data to a second erase block, the second erase block being different from the first erase block; and
(c) erasing all data in the first erase block.

2. The method for erasing the file according to claim 1, wherein the steps (a) through (c) are repeated.

3. A method for erasing a file from a storage medium having a nonvolatile semiconductor storage device, the nonvolatile semiconductor storage device including a plurality of erase blocks each including a plurality of memory cells allowing data stored thereon to be erased collectively, the method comprising:
(a) writing second data of the file to a part of a first erase block; and
(d) over-writing data to the part of the first erase block such that all memory cells corresponding to the file are rendered in the same electronic state.

4. The method for erasing the file according to claim 3 further comprising:
(b) after the step (a), reading first data from the first erase block, the first data being different from second data; and
(c) after the step (b), writing the first data to a second erase block, the second erase block being different from the first erase block before the step (d).

5. The method for erasing the file according to claim 4, wherein the steps (a) through (d) are repeated.

6. A method for erasing a file from a storage medium having a nonvolatile semiconductor storage device, the nonvolatile semiconductor storage device including a plurality of erase blocks each including a plurality of memory cells allowing data stored thereon to be erased collectively, the method comprising:
(a) reading first data from a first erase block, the first data being different from second data of an file in the erase block;
(b) temporally storing the first data to a temporally storage;
(c) erasing all data in the first erase block; and
(d) writing the first data to the first erase block.

7. The method for erasing the file according to claim 6, wherein the temporally storage is a second erase block other than the first erase block in which the file is recorded.

8. The method for erasing the file according to claim 6, wherein the temporally storage includes a RAM.

9. The method for erasing the file according to claim 6, wherein the steps (a) through (d) are repeated.

10. The method for erasing the file according to claim 1, wherein the steps (a) through (c) are performed by a controller.

11. The method for erasing the file according to claim 3, wherein the steps (a) and (d) are performed by a controller.

12. The method for erasing the file according to claim 6, wherein the steps (a) through (d) are performed by a controller.

13. The method for erasing the file according to claim 1, wherein the nonvolatile semiconductor storage device is a B4 flash memory.

14. The method for erasing the file according to claim 3, wherein the nonvolatile semiconductor storage device is a B4 flash memory.

15. The method for erasing the file according to claim 6 wherein the nonvolatile semiconductor storage device is a B4 flash memory.

16. The method for erasing the file according to claim 1, wherein the nonvolatile semiconductor storage device is included in a data terminal.

17. The method for erasing the file according to claim 3, wherein the nonvolatile semiconductor storage device is included in a data terminal.

18. The method for erasing the file according to claim 6, wherein the nonvolatile semiconductor storage device is included in a data terminal.

19. The method for erasing the file according to claim 16, wherein the storage medium stores user data.

20. The method for erasing the file according to claim 17, wherein the storage medium stores user data.

21. The method for erasing the file according to claim 18, wherein the storage medium stores user data.
